(19) United States
(12) Patent Application Publication
(10) Pub. No.: US 2023/0082645 A1
(43) Pub. Date: Mar. 16, 2023

(54) SPIRAL PLUNGER WEEDER

(71) Applicant: Linda D. Jordan, Colville, WA (US)

(72) Inventor: Linda D. Jordan, Colville, WA (US)

(21) Appl. No.: 17/472,636

(22) Filed: Sep. 12, 2021

(51) Int. Cl. A01B 1/16

(52) U.S. Cl. CPC A01B 1/16

(57) ABSTRACT

An illustrated view of an exemplary weeder for removing weeds from a garden and/or yard is presented. The weeder is useful for providing transfer of a user from one location to another location.

### FIELD OF THE INVENTION

This invention relates to garden weeders. More particularly, it relates to a spiral plunger for a garden weeder.

### BACKGROUND

A garden is a planned space, usually outdoors, set aside for the display, cultivation, or enjoyment of plants and other forms of nature, as an ideal setting for social or solitary human life. The single feature identifying even the wildest wild garden is control. The garden can incorporate both natural and man-made materials.

Gardens often have design features including statuary, follies, pergolas, trellises, stumperies, dry creek beds and water features such as fountains, ponds (with or without fish), waterfalls or creeks. Some gardens are for ornamental purposes only, while others also produce food crops, sometimes in separate areas, or sometimes intermixed with the ornamental plants. Food-producing gardens are distinguished from farms by their smaller scale, more labor-intensive methods, and their purpose (enjoyment of a hobby or self-sustenance rather than producing for sale, as in a market garden). Flower gardens combine plants of different heights, colors, textures, and fragrances to create interest and delight the senses.

Landscape architecture is a related professional activity with landscape architects tending to engage in design at many scales and working on both public and private projects. The most common form today is a residential or public garden, but the term garden has traditionally been a more general one.

A weed is a plant considered undesirable in a particular situation; “a plant in the wrong place”. Examples commonly are plants unwanted in human-controlled settings, such as farm fields, gardens, lawns, and parks. Taxonomically, the term “weed” has no botanical significance, because a plant that is a weed in one context is not a weed when growing in a situation where it is in fact wanted, and where one species of plant is a valuable crop plant, another species in the same genus might be a serious weed, such as a wild bramble growing among cultivated loganberries. In the same way, volunteer crops (plants) are regarded as weeds in a subsequent crop. Many plants that people widely regard as weeds also are intentionally grown in gardens and other cultivated settings, in which case they are sometimes called beneficial weeds. The term weed also is applied to any plant that grows or reproduces aggressively or is invasive outside its native habitat. More broadly “weed” occasionally is applied pejoratively to species outside the plant kingdom, species that can survive in diverse environments and reproduce quickly.

Weed control is important in agriculture. Methods include hand cultivation with hoes, powered cultivation with cultivators, smothering with mulch or soil solarization, lethal wilting with high heat, burning, or chemical attack with herbicides.

Weeds are unwanted and often grow unhindered in gardens and yards. People spend a lot of money to rid their yard and gardens of weeds, most commonly by use of insecticides. Insecticides are harmful to the environment and can cause damage to plants and grass as well as are harmful to animals. Currently used weeders are often difficult to use and can be troublesome to insert into the ground around the weeds. This can cause an excessive amount of time and energy to remove the weeds in a non-toxic manner.

Accordingly, and in light of the foregoing, it would be desirable to devise a weeding device that provides a mechanism to more easily be inserted into the ground to remove the weed from the roots. It would be further advantageous if the device were more comfortable for a person, and is more efficient, faster and cause less anguish for the person trying to de-weed their garden and/or yard.

### BRIEF DESCRIPTION OF THE DRAWINGS

FIG. 1A is an illustrated view of an exemplary weeder.

FIG. 1B is an illustrated view of a de-actuated (or at-rest) plunger of the weeder shown in FIG. 1A.

FIG. 1C is an illustrated view of an actuated plunger of the weeder shown in FIG. 1A.

### DETAILED DESCRIPTION

The phrases “in one embodiment,” “in various embodiments,” “in some embodiments,” and the like are used repeatedly. Such phrases do not necessarily refer to the same embodiment. The terms “comprising,” “having,” and “including” are synonymous, unless the context dictates otherwise. Such terms do not generally signify a closed list.

“Above,” “adhesive,” “affixing,” “any,” “around,” “both,” “bottom,” “by,” “comprising,” “consistent,” “customized,” “enclosing,” “friction,” “in,” “labeled,” “lower,” “magnetic,” “marked,” “new,” “nominal,” “not,” “of,” “other,” “outside,” “outwardly,” “particular,” “permanently,” “preventing,” “raised,” “respectively,” “reversibly,” “round,” “square,” “substantial,” “supporting,” “surrounded,” “surrounding,” “threaded,” “to,” “top,” “using,” “wherein,” “with,” or other such descriptors herein are used in their normal yes-or-no sense, not as terms of degree, unless context dictates otherwise.

Reference is now made in detail to the description of the embodiments as illustrated in the drawings. While embodiments are described in connection with the drawings and related descriptions, there is no intent to limit the scope to the embodiments disclosed herein. On the contrary, the intent is to cover all alternatives, modifications and equivalents. In alternate embodiments, additional devices, or combinations of illustrated devices, may be added to, or combined, without limiting the scope to the embodiments disclosed herein.

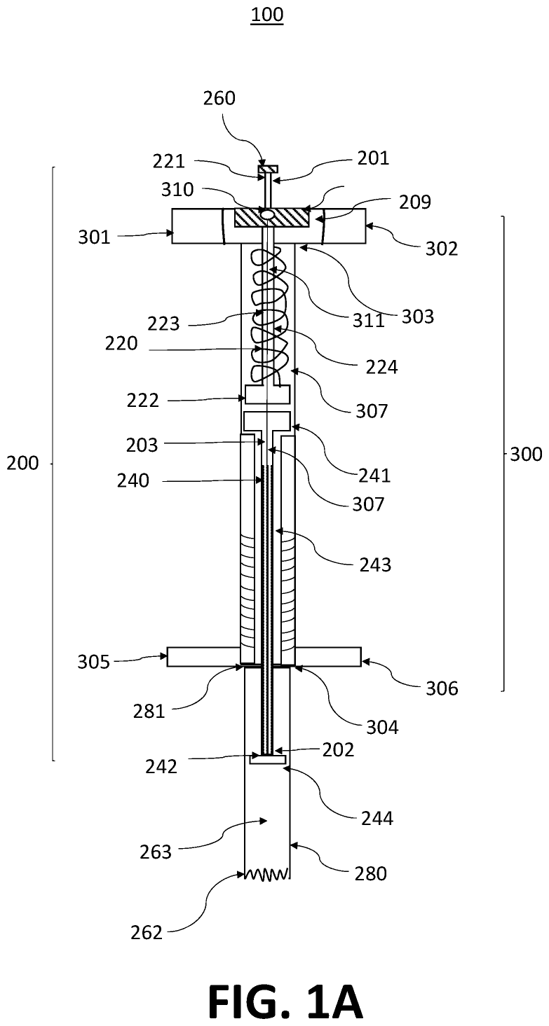

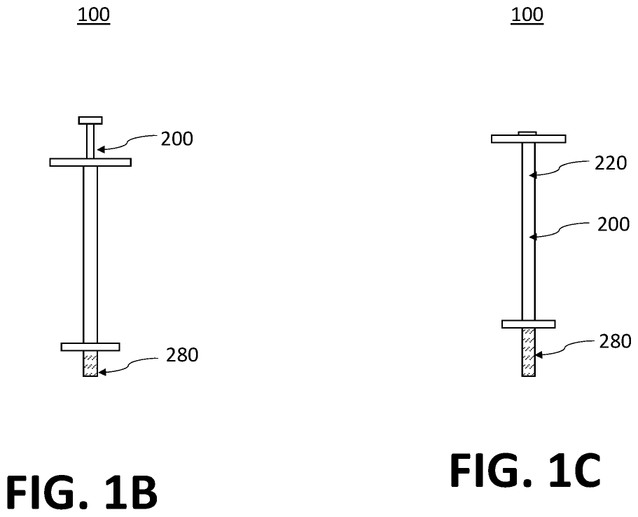

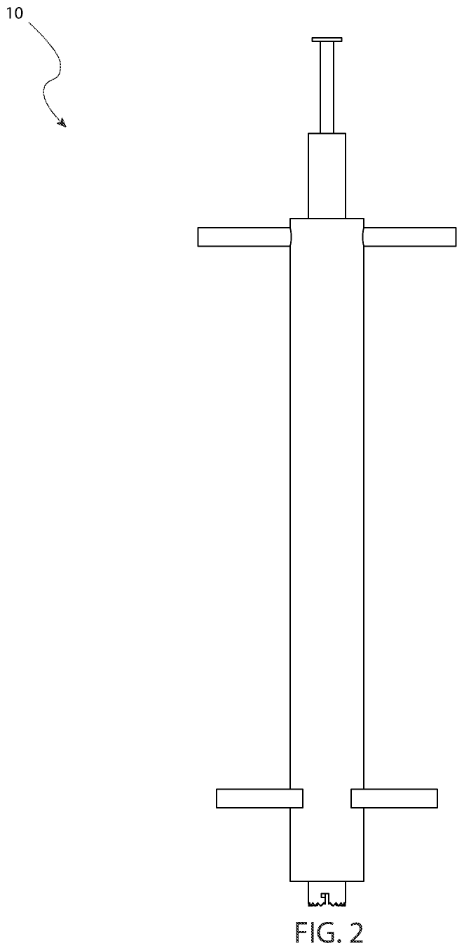

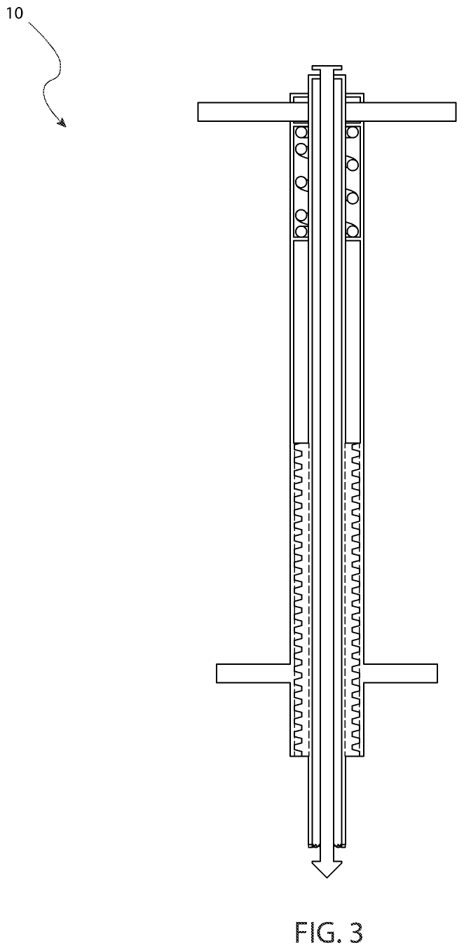

Referring to FIG. 1A, FIG. 1B and FIG. 1C, an illustrated view of an exemplary weeder 100 for removing weeds from a garden and/or yard is presented. The weeder 100 is useful for providing transfer of a user from one location to another location. Also, the system 100 is useful for lifting a user and moving the user to a side or from side to side to allow the changing of sheets or other bedding material.

The weeder 100 is preferably fifty-four and one-half (54.5) inches in length, however other lengths are hereby contemplated, including, but not limited to, fifty (50) inches, fifty-seven (57) inches, etc.

The weeder 100 has a plunger 200 and a body 300.

The body 300 has a plurality of handles 301, 302, a top 303, a bottom 304 an inside 307 and a plurality of foot brackets 305, 306. The handles 301, 302 are coupled to the top of the body 300. The handles 302, 303 are useful for a person to have a secure control of the weeder 100. The foot brackets 305, 306 are coupled to the bottom 304 of the body 300. The foot brackets 305, 306 are useful for allowing the person to be able to use a foot to apply force onto the weeder 100 to push the weeder into a ground. The inside 307 of the body 300 is preferably hollow.

The plunger 200 has a top 201, a bottom 202, an inside 203, a first portion 220 and a second portion 240. The first portion 220 has a top 221 and a footing 222. The bottom portion 240 has a top 241 and a footing 242. A handle 260 is coupled to the top 221 of the first portion 220. The footing 222 of the first portion 220 is preferably elongated such that the footing 222 is wider than a width of a middle 224 the first portion 220 of the plunger 200. The footing 242 of the second portion 240 is preferably elongated such that the footing 242 is wider than a width of a middle 244 the second portion 240 of the plunger 200.

The handles 301, 302 are coupled to the top 201 of the plunger 200. A middle 209 of the top 303 of the body 300 has an opening 308 such that the handles 301, 302 do not enter into the inside 307 of the body 300, that allows for a connecting bar 311 to be inserted through the body 300 and through the first portion 220 and the second portion 240 of the plunger 200. The top 303 of the body 300 is recessed for holding the top 221 of the first portion 220 of the plunger 200.

The footing 242 of second portion 240 the first plunger 200 is further elongated such that the footing 242 is wider than a middle portion 243 of the second portion 240 of the first plunger 200. The top 241 of the second portion 240 of the plunger 200 is significantly the same width as the bottom 222 of the first plunger 200. A rod end cap 244 is coupled to the bottom 242 of the second portion 240 of the plunger 200 and the rod end cap 244 is wider than a middle portion 243 of the second portion 240 of the plunger 200. The bottom 222 of the first portion 220 of the plunger 200 is removably coupled to the top 241 of the second portion 240 of the plunger 200.

A spring 260 is movably coupled to the inside 307 of the body 300. The middle portion 223 of the first portion 220 of the plunger 200 is surrounded by the spring 260. The spring 260 is useful for automation of the plunger 200 to be returned to an at-rest state.

A pipe 280 has a top 281, an inside 282 and a bottom 283. The bottom 283 of the inside 282 of the pipe 280 is preferably hollow. The rod end cap 244 coupled to the inside 282 of the pipe 280. The bottom 282 of the body 300 is preferably serrated. The bottom 283 of the pipe 280 is preferably jagged in shape, such that the pipe 280 is easily manipulated through the ground, such that the person exerts little force in the use of the weeder 100.

The person holds onto the handles 301, 302 of the body 300 and places pipe 260 of the weeder 100 over and around the weed. The person places their feet on the foot brackets 305, 306 of the body 300 and exerts pressure on the foot brackets 305, 306 thus pushing the pipe 280 into the ground. Once the pipe 260 has fully been pushed into a desired depth of the ground, the weed is fully engaged within the pipe 280.

The weeder 100 is then removed from the ground and the person then pushes the top 221 of the first portion 220 of the plunger 200 to actuate the plunger 200 to release the weed, dirt, etc., contained within the pipe 280. The person then releases the top 221 of the first portion 220 of the plunger 200 to de-actuate the plunger 200 thus allowing for another use of the weeder 100.

FIG. 1B presents that weeder 100 in an at-rest state, such that the plunger 200 is not in actuated. The weeder 100 is in a ready condition to have the pipe 280 inserted into the ground.

FIG. 1C, presents the top 241 of the first portion 220 of the plunger 200 having been actuated such that the dirt, weed and other debris is pushed outward from the pipe 280.

In the numbered clauses below, specific combinations of aspects and embodiments are articulated in a shorthand form such that (1) according to respective embodiments, for each instance in which a “component” or other such identifiers appear to be introduced (with “a” or “an,” e.g.) more than once in a given chain of clauses, such designations may either identify the same entity or distinct entities; and (2) what might be called “dependent” clauses below may or may not incorporate, in respective embodiments, the features of “independent” clauses to which they refer or other features described above.

Those skilled in the art will appreciate that the foregoing specific exemplary processes and/or devices and/or technologies are representative of more general processes and/or devices and/or technologies taught elsewhere herein, such as in the claims filed herewith and/or elsewhere in the present application.

The features described with respect to one embodiment may be applied to other embodiments or combined with or interchanged with the features of other embodiments, as appropriate, without departing from the scope of the present invention.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A weeder for removing weeds from a garden and/or lawn, the weeder comprising:
a body, the body comprising:
a plurality of handles, the handles coupled to a top of the body;
a plurality of foot brackets, the foot brackets coupled to the bottom of the body;
an inside, the inside being hollow;
a top of the body having a middle, wherein the middle having a recessed area and an opening;
a plunger, the plunger comprising:
a first portion, the first portion having a top, a bottom and an inside;
a second portion, the second portion having a top, a bottom and an inside;
a handle, the handle coupled to the top of the first portion of the plunger;
the top of the second portion being wider than the middle of the second portion;
the middle of the plunger being hollow;
a spring, the spring being configured on the inside of the body, and wherein the spring being configured to be around the first portion of the plunger; and
a pipe, the pipe having a top, a middle and a bottom, wherein the top of the pipe being coupled to the bottom of the body.

2. The weeder of claim 1, the bottom of the pipe is serrated.

3. The weeder of claim 1, wherein the bottom of the first portion is a footing.

4. The weeder of claim 3, wherein the footing of the first portion is wider than the middle of the first portion.

5. The weeder of claim 1, wherein the bottom of the second portion is a footing.

6. The weeder of claim 5, wherein the footing of the second portion is wider than the middle of the second portion.
